(19) United States
(12) Patent Application Publication
(10) Pub. No.: US 2025/0297695 A1
(43) Pub. Date: Sep. 25, 2025

(54) Solar Cable Support Bracket

(71) Applicant: HellermannTyton Corporation, Milwaukee, WI (US)

(72) Inventors: Scott G. Klos, Grafton, WI (US); Michael Toll, Whitefish Bay, WI (US); Daniel S. Uhler, Milwaukee, WI (US)

(21) Appl. No.: 18/748,509

(22) Filed: Jun. 20, 2024

Related U.S. Application Data
(60) Provisional application No. 63/568,808, filed on Mar. 22, 2024.

(51) Int. Cl. F16L 3/233; F16L 3/10; F16L 3/12

(52) U.S. Cl. CPC F16L 3/2336; F16L 3/1033; F16L 3/12

(57) ABSTRACT

Disclosed are improved support brackets that are configured for the installation and routing of one or more elongated objects relative to a workpiece. A support bracket may include a first hanger portion configured to support an edge of the workpiece and limit the rotation of the support bracket on the edge of the workpiece. A support bracket may include a clip portion configured to fasten over the edge of the workpiece, the clip portion including a first connector configured to engage at least one of a first web face or a second web face of the workpiece. A support bracket may include a cable tie retainer defining an aperture configured to receive a cable tie therethrough, the cable tie retainer configured to receive the cable tie to attach the elongated object to the support bracket. A support bracket may include an object support section configured to support the elongated object.

### INCORPORATION BY REFERENCE

This application claims the benefit of U.S. Provisional Application No. 63/568,808, filed on Mar. 22, 2024, the disclosure of which is incorporated by reference herein in its entirety.

### BACKGROUND

A photovoltaic system installation includes one or more panels (e.g., solar panels) of photovoltaic cells that are mounted on and/or supported by a workpiece. The electrical output of the solar panels is transferred to the electrical grid or an electrical storage device (e.g., battery) through one or more solar cables, which may be routed along the workpiece through the use of at least one fixing (e.g., a cable tie, a mounting clamp, an adhesive cable tie saddle and a cable tie, an edge clip and a cable tie, a wedge clip and a cable tie). The fixing may be utilized as an anchoring point to attach the routed solar cables to the workpiece.

### SUMMARY

This document describes support brackets, including solar cable support brackets.

In some implementations, the techniques described herein relate to a support bracket configured to receive (e.g., engage) an edge of a workpiece and support an elongated object relative to the workpiece, the support bracket including a first hanger portion configured to support the edge of the workpiece and limit a rotation of the support bracket on the edge of the workpiece; a clip portion configured to fasten over the edge of the workpiece, the clip portion including a first connector configured to engage at least one of a first web face or a second web face of the workpiece; a cable tie retainer defining an aperture configured to receive a cable tie therethrough, the cable tie retainer configured to receive the cable tie to attach the elongated object to the support bracket; and an object support section configured to support the elongated object.

In some implementations, the techniques described herein relate to a support bracket configured to receive an edge of a workpiece and support an elongated object relative to the workpiece, the support bracket including: a first hanger portion configured to support the edge of the workpiece and limit a rotation of the support bracket on the edge of the workpiece, the first hanger portion including: a first sidewall spaced apart from a second sidewall by a first support ledge, the first and second sidewalls defining a first channel therebetween that is configured to receive the edge of the workpiece through an opening opposite the first support ledge, wherein the first support ledge is configured to rest on the edge of the workpiece; a second hanger portion configured to support the edge of the workpiece and limit the rotation of the support bracket on the edge of the workpiece, the second hanger portion spaced apart from the first hanger portion, the second hanger portion including: a third sidewall spaced apart from a fourth sidewall by a second support ledge, the third and fourth sidewalls defining a second channel therebetween that is configured to receive the edge of the workpiece through a second opening opposite the second support ledge, the second support ledge configured to rest on the edge of the workpiece; and an object support section configured to support the elongated object.

This Summary is provided to introduce simplified concepts of solar cable support brackets, which are further described below in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more implementations of solar cable support brackets are described with reference to the following Drawings.

FIG. 1 is a perspective view of a first solar cable support bracket, where a clip portion is an edge clip fixing.

FIG. 2A is a cross-sectional view along line 2A-2A in FIG. 1.

FIG. 2B is a cross-sectional view along line 2B-2B in FIG. 1.

FIG. 3 is a perspective view of a clip portion that is a wedge clip fixing.

FIG. 4 is a perspective view of a second solar cable support bracket.

FIG. 5A is a perspective view of a third solar cable support bracket.

FIG. 5B is a right-side view of the solar cable support bracket of FIG. 5A.

FIG. 5C is a cross-sectional view along line 5C-4C in FIG. 5B.

FIG. 5D is an end view of the solar cable support bracket of FIG. 5A.

FIG. 6 is a perspective view of a fourth solar cable support bracket.

FIG. 7 is a perspective view of a fifth solar cable support bracket.

FIG. 8A is a front perspective view of a sixth solar cable support bracket.

FIG. 8B is a right-side view of the solar cable support bracket of FIG. 8A.

The following detailed description of example implementations of solar cable support brackets refers to the accompanying Drawings. The same call-out numbers in different Drawings may identify the same or similar features, elements, and/or components. The first digit(s) of a call-out number may correlate with the first figure number in which the call-out number is labeled. For example, call-out numbers that start with a 1 (e.g., support bracket 102, clip portion 110) may represent details first called out with respect to FIG. 1.

For clarity, a Cartesian coordinate system is used and is labeled in the figures. The coordinate system includes three dimensions, namely, an X-axis, a Y-axis, and a Z-axis. Each of the three axes is orthogonal to the other two axes. The X-axis and the Y-axis define a horizontal plane, with the Z-axis in a vertical direction. While the origin of the coordinate system may be placed at any point on or near the components of a solar cable support bracket, for the purposes of description, the axes of the coordinate system are always disposed along the same directions from figure to figure, unless indicated otherwise. In some examples, reference may be made to dimensions, angles, directions, relative positions, and/or movements associated with one or more components of a solar cable support bracket with respect to the coordinate system. For instance, the width of a solar cable support bracket may be defined as a dimension along the X-axis, the depth of the solar cable support bracket may be defined as a dimension along the Y-axis, and the height of the solar cable support bracket may be defined as a dimension along the Z-axis of the coordinate system.

### DETAILED DESCRIPTION

Improved support brackets (e.g., solar cable support brackets) are described in this document. The solar cable support brackets (referred to herein as a “support bracket”) are configured for the installation and routing of one or more elongated objects (e.g., solar cables, photovoltaic cables, electrical cables, wires, pipes, and bundles of the same) relative to a workpiece (e.g., a support surface, a web of an I-beam, an edge of a panel, an edge of sheet, an edge of a plate, an edge of a bar, and the like). Also disclosed are systems that include a support bracket that includes at least one fixing (e.g., a mounting clamp, an edge clip fixing, a wedge clip fixing, one or more resilient arms) and at least one cable tie.

The disclosed solar cable support brackets may be configured to manage solar cables during installation of the photovoltaic system, configured to cinch solar cables during and/or after the installation of the photovoltaic system, configured to securely clip to the workpiece, and/or configured to make it easier to install solar cables during the installation of the photovoltaic system. In implementations, a support bracket includes a clip portion that is configured to fasten over an edge of the workpiece, at least one hanger portion that is configured to support the edge of the workpiece (e.g., hang over the edge of the workpiece), and an object support section that is configured to support the elongated object (e.g., spaced apart from the workpiece). The object support section may include a cross brace and at least one cradle arm. A pair of cradle arms (e.g., a first cradle arm, a second cradle arm) may define a cradle therebetween, which is configured to retain the elongated object while allowing for easy access for an installer during installation.

The object support section is configured to support the object relative to (e.g., above) the workpiece. In implementations, the object support section is configured to prevent damage to the object as the solar cables are routed (e.g., pulled) across the support bracket. The support bracket (e.g., a clip portion and/or a hanger portion) may include a cable tie retainer (e.g., cable tie pass-through, cable tie retaining geometry, cable tie saddle) that is configured to receive a cable tie therethrough. A cable tie retainer may include one or more apertures, slots, and the like. The cable tie is configured to attach the solar cable(s) to the support bracket (e.g., at the clip portion, at the hanger portion).

The clip portion is configured to fasten over the edge of the workpiece (e.g., the web of an I-beam, the edge of a panel). The clip portion may be connected to the support bracket or may be separate from the support bracket. The clip portion may include one or more connectors that are configured to engage a web face of the workpiece. A connector may include one or more clip arms that are configured to slide onto the edge. The clip arms define a gap therebetween that is configured to receive the edge therein. One or more clip arms may be located on alternate sides of the gap, and a pair of clip arms may be located on opposing sides of the gap. In implementations, the clip arms are resilient clip arms (e.g., spring clip arms).

The hanger portion may support the edge of the workpiece and limit the rotation of the support bracket on the edge of the workpiece around the Y-axis (e.g., at the attachment to the clip portion). Contact between the hanger portion and the edge of the workpiece may limit rotation of the support bracket. The support bracket may include a face mount portion configured to mount the support bracket to a face or another surface of the workpiece. In one example, the face mount portion includes at least one magnet configured to magnetically attach to a face of the workpiece (e.g., a side of an I-beam). The face mount portion may include a lever portion (e.g., a finger tab) that is configured to assist a user in the detachment of the magnet of the face mount portion from the face of the workpiece.

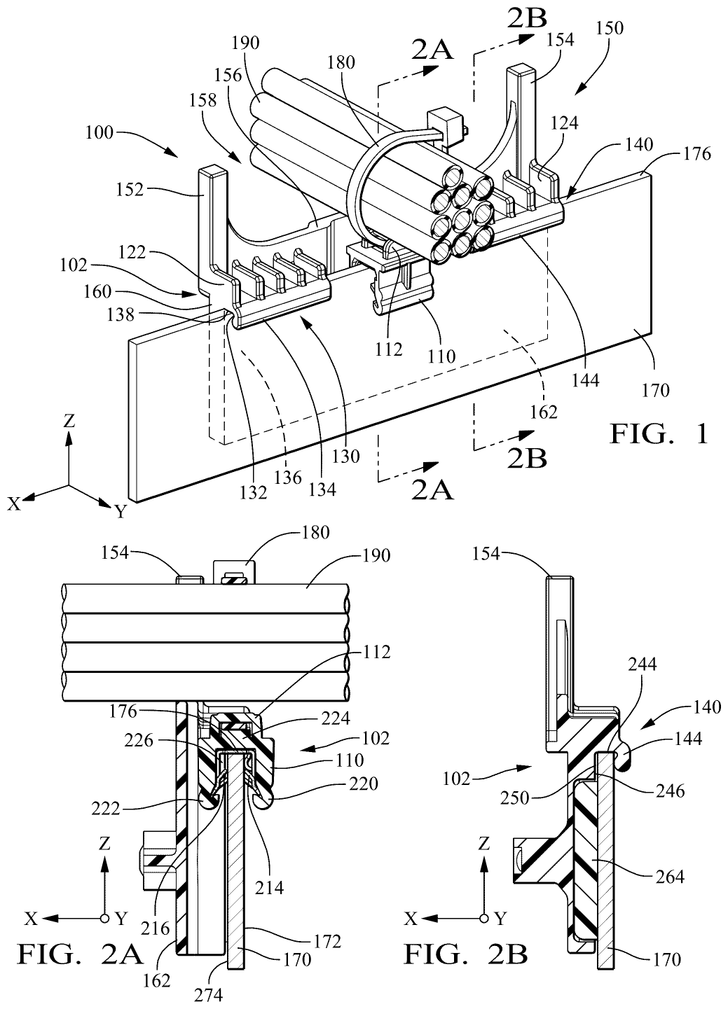

FIGS. 1, 2A, and 2B are illustrations of a system 100 that includes a solar cable support bracket (support bracket 102), at least one workpiece (workpiece 170), at least one cable tie (cable tie 180), and at least one elongated object (elongated object 190). The support bracket 102 is configured to receive the workpiece 170 (e.g., at an edge 176 of the workpiece 170) and support the elongated object 190 relative to the workpiece 170. The workpiece 170 includes a first web face 172 opposite a second web face 274.

The support bracket 102 includes a clip portion 110 that is configured to fasten over the edge 176 of the workpiece 170 to connect the clip portion 110 with an end portion of the workpiece 170. In the implementation illustrated in FIGS. 1, 2A, and 2B, the clip portion 110 is separate from the support bracket 102. In other implementations, the clip portion 110 may be integral with the support bracket 102. In additional implementations, a clip portion may be omitted. A clip portion may include one or more clip arms that are configured to slide onto the edge 176 of the workpiece 170. The clip portion 110 includes a first clip arm 220, a second clip arm 222 arranged opposite the first clip arm 220, and an end wall 224 that interconnects the first and second clip arms. The first and second clip arms define a gap 226 therebetween. The gap 226 is configured to receive the edge 176 of the workpiece 170 through an opening that is opposite the end wall 224. The first and second clip arms may have sufficient elasticity to be able to resiliently, if not elastically, deform to slip onto the edge 176 of the workpiece 170 and contact a web face of the workpiece 170. In the clip portion 110, the first clip arm 220 and the second clip arm 222 are paired together and face one another on opposite sides of the gap 226.

In the implementation illustrated in FIGS. 1, 2A, and 2B, the clip portion 110 is illustrated as an edge clip fixing. In other implementations, the clip portion 110 may be a wedge clip fixing (e.g., clip portion 310 of FIG. 3) or another form of fixing that is configured to fasten over the edge 176 of the workpiece 170 to connect the clip portion 110 with an end portion of the workpiece 170. A clip portion (e.g., clip portion 110) may include one or more connectors that are configured to engage a web face (e.g., first web face 172, second web face 274) of a workpiece. The clip portion includes at least one connector that is configured to engage at least one of a first web face or a second web face of the workpiece. For example, the clip portion 110 includes a first connector that is configured to engage a first web face 172 of the workpiece 170 and includes a second connector that is configured to engage a second web face 274 of the workpiece 170. In FIGS. 1, 2A, and 2B, the first connector includes at least one resilient cantilevered prong (first resilient cantilevered prong 214) that projects into a gap 226 from a first clip arm 220 and the second connector includes at least one resilient cantilevered prong (second resilient cantilevered prong 216) that projects into the gap 226 from a second clip arm 222. The resilient cantilevered prongs are configured to exert a spring force on the workpiece 170 in order to retain the clip portion 110 on the edge 176 of the workpiece 170. The resilient cantilevered prongs may include free ends that are located opposite the opening. As the edge 176 of the workpiece 170 is inserted into the gap 226, the web faces (e.g., first web face 172, second web face 274) of the workpiece 170 contact the resilient cantilevered prongs. This contact may cause the first resilient cantilevered prong 214 to flex toward the first clip arm 220 while the second resilient cantilevered prong 216 flexes toward the second clip arm 222. The resilient cantilevered prongs are configured to “bite” into the web faces (e.g., first web face 172, second web face 274) of the workpiece 170 as the clip portion 110 is moved a direction away from the edge 176 of the workpiece 170, which causes the first resilient cantilevered prong 214 to flex toward the second clip arm 222 and the second resilient cantilevered prong 216 to flex toward the first clip arm 220, thereby increasing a removal force.

The support bracket 102 may include at least one hanger portion (e.g., first hanger portion 130, second hanger portion 140) that is configured to support the edge 176 of the workpiece 170 and limit the rotation of the support bracket 102 around the Y-axis (e.g., at the attachment to the clip portion 110). The rotation may be limited by contact between the hanger portion and the edge 176 of the workpiece 170. In implementations, a hanger portion may be omitted. The support bracket 102 may include a body 160 and the hanger portion may protrude from the body 160 (e.g., in the Y-direction) and function as a guide for guiding elongated objects (e.g., solar cables) during the pulling and/or routing of the elongated objects.

In implementations with multiple hanger portions, the hanger portions may be spaced apart from one another, for example as illustrated in FIG. 1, where the first hanger portion 130 is spaced apart from the second hanger portion 140. Further, hanger portions may be spaced apart from one another with a clip portion positioned therebetween, for example as illustrated in FIG. 1, where the first hanger portion 130 is spaced apart from the second hanger portion 140 with the clip portion 110 positioned therebetween.

A hanger portion (e.g., first hanger portion 130, second hanger portion 140) may include an inner sidewall, an outer sidewall arranged opposite the inner sidewall, and a support ledge that interconnects the inner and outer sidewalls. The inner and outer sidewalls define a channel (e.g., first channel 132, second channel 250) therebetween that is configured to receive the edge 176 of the workpiece 170 through an opening (e.g., first opening, second opening) opposite the support ledge (e.g., first support ledge 138, second support ledge 244), thereby enabling the support ledge to rest on the edge 176 of the workpiece 170. The inner sidewalls and/or the outer sidewalls may be rigid. In implementations, the combination of resilient clip arms and rigid sidewalls may provide for a tight, robust fit on a workpiece.

The outer sidewalls (e.g., first sidewall 134, third sidewall 144) may be arranged on alternate sides of the channel (e.g., first channel 132, second channel 250) from the inner sidewalls (e.g., second sidewall 136, fourth sidewall 246). In this configuration, the outer sidewalls are positioned away from the body 160 and the inner sidewalls are positioned nearer the body 160. In implementations, the body 160 may form one or more of the inner sidewalls.

The support ledge is configured to rest on the edge 176 of the workpiece 170. In the implementation of FIGS. 1, 2A, and 2B, a first support ledge 138 interconnects the first sidewall 134 and the second sidewall 136 and a second support ledge 244 interconnects the third sidewall 144 and the fourth sidewall 246. The support ledges may be parallel to one another and plumb-aligned.

A sidewall (e.g., inner sidewall, outer sidewall) of a hanger portion may be configured to contact a web face of the workpiece 170. For example, as illustrated in FIGS. 1, 2A, and 2B, the third sidewall 144 is configured to contact the first web face 172 of the workpiece and the fourth sidewall 246 is configured to contact the second web face 274 of the workpiece. One or more of the first channel 132, the gap 226, or the second channel 250 may receive the edge 176 of the workpiece 170. In implementations, the gap 226, the first channel 132, and the second channel 250 are configured to individually receive the edge 176 of the workpiece 170.

The system 100 (e.g., support bracket 102, clip portion 110) may include at least one cable tie retainer (e.g., cable tie pass-through, cable tie retaining geometry, cable tie saddle) that defines at least one aperture, slot, and the like that is configured to receive a cable tie (e.g., cable tie 180) therethrough. The cable tie may be utilized to attach the elongated object 190 to the support bracket 102 and/or the clip portion 110. In implementations, one or more of the clip portion 110 or a hanger portion (e.g., first hanger portion 130, second hanger portion 140) may include a cable tie retainer. In the implementation of FIGS. 1, 2A, and 2B, the clip portion 110 includes a cable tie retainer 112.

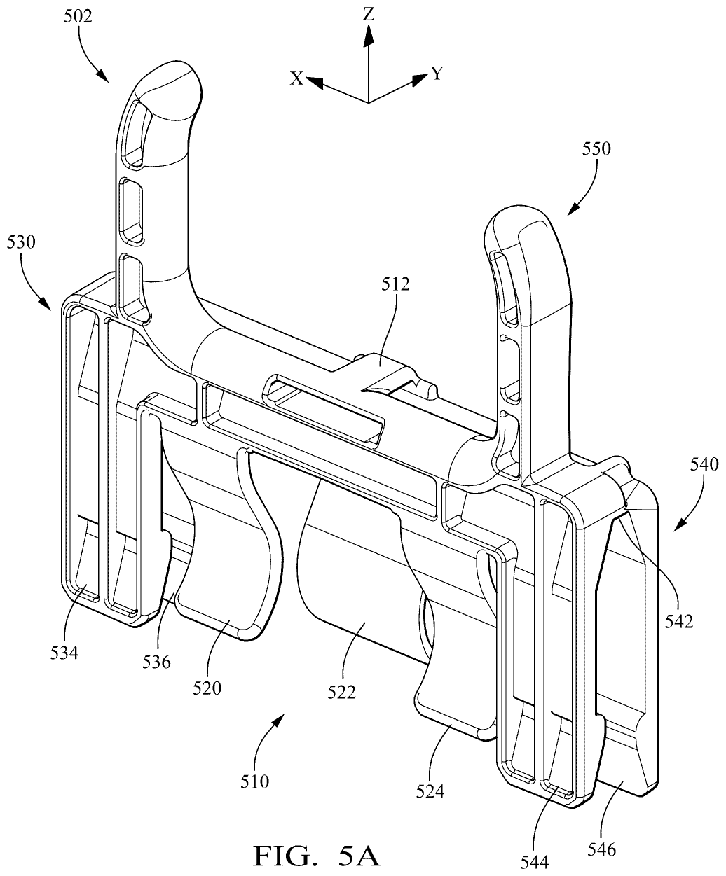

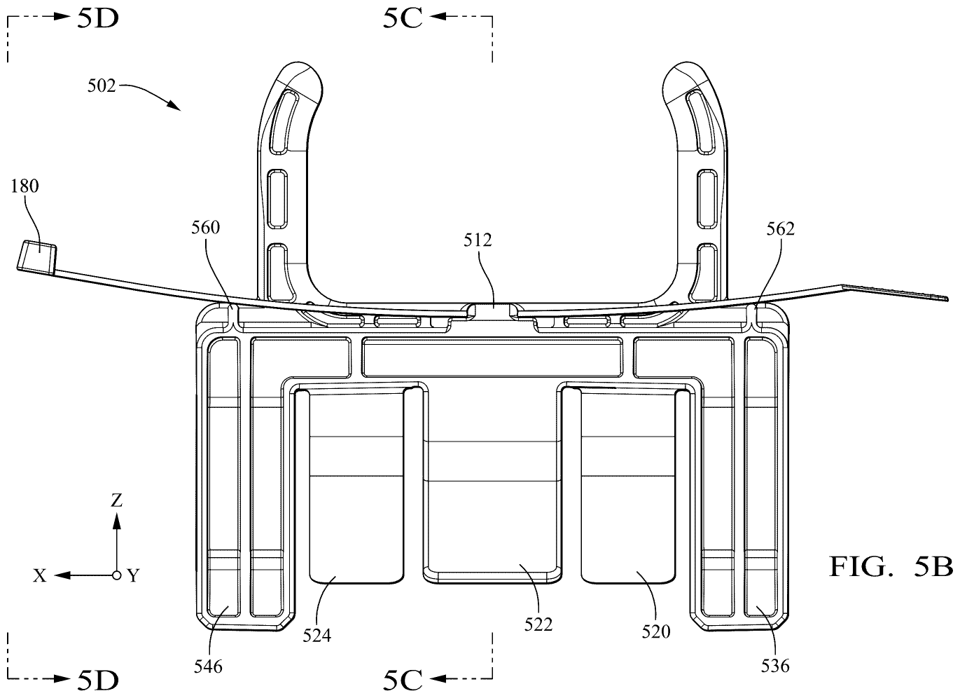

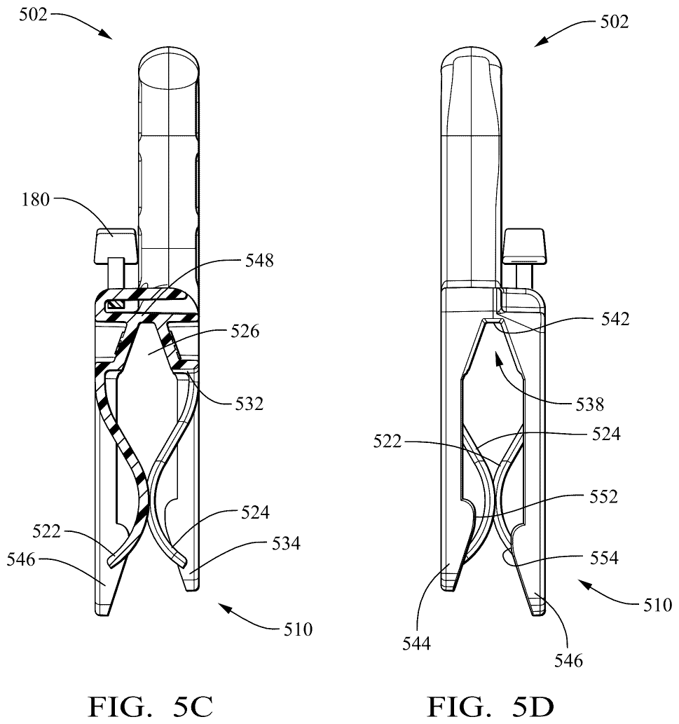

A support bracket (e.g., support bracket 102, support bracket 502, support bracket 602, support bracket 702, support bracket 802) may include at least one rib that is configured to bend a loose cable tie (e.g., a cable tie that does not have its elongated strap inserted through the locking head of the cable tie to form a loop) inserted through a cable tie retainer to retain the cable tie on the support bracket. For example, as illustrated in FIG. 1, the hanger portions (e.g. first hanger portion 130, second hanger portion 140) include one or more ribs (e.g., rib 122, rib 124) that are configured to provide a static grip on the cable tie 180 while installed in the cable tie retainer 112. In this way, a support bracket may be provided to customers preassembled with a pre-installed cable tie inserted through the cable tie retainer 112. The rib feature is also illustrated in FIG. 5B, with respect to the support bracket 502.

The support bracket 102 may include an object support section 150, which is configured to support the elongated object 190 relative to (e.g., above) the workpiece 170. The object support section 150 may include at least one cradle arm (e.g., a first cradle arm 152, a second cradle arm 154) and a cross brace 156. The cradle arms may be spaced apart to define a cradle (e.g., cradle 158) therebetween, which may define goal post-shaped geometry for the cradle. The cradle is configured to retain the elongated object 190 while allowing for easy access for an installer during installation. The cradle arms and/or cross brace may include large radiused contact edges that are configured to protect (e.g., from chaffing) the elongated object (e.g., cables) when routed across and pulled through the cradle. The cradle arms may be curved inwards (e.g., along their distal ends) to decrease the likelihood that routed elongated objects will overflow outside of the cradle as it fills.

The body 160 of the support bracket 102 may include a face mount portion 162 that is configured to mount the support bracket 102 to a face or another surface of the workpiece 170. In one example, the face mount portion 162 includes at least one magnet 264 that is configured to magnetically attach to a face of a workpiece (e.g., the first web face 172) of a ferromagnetic material. The magnet 264 may attach to the support bracket 102 via an adhesive (e.g., epoxy), a screw mount, a press fit, and the like. In implementations, a support bracket includes a face mount portion. In implementations, a face mount portion may be omitted.

The support bracket 102 may be configured for use as a tool that is configured for temporary installation to the workpiece 170. In such a configuration, the support bracket 102 may hold the elongated object 190 by virtue of gravity force holding down the elongated object 190 against the cross brace 156, flanked by the upright cradle arms (e.g., first cradle arm 152, second cradle arm 154). The support bracket 102 may be utilized to guide elongated objects (e.g., solar cables) during the pulling and/or routing of the elongated objects and until a separate fixing (e.g., edge clip fixing, wedge clip fixing) is attached to the workpiece 170 to fix the elongated objects to the workpiece 170 via the fixing. After the fixing is attached, the support bracket 102 may be removed. In implementations, the support bracket 102 may be permanent or semi-permanent, utilized to guide the elongated objects during the pulling of the elongated objects and left attached to the workpiece 170 after installation.

As discussed above, in the implementation illustrated in FIGS. 1, 2A, and 2B, the clip portion 110 is illustrated as an edge clip fixing. Examples of edge clip fixings include the retaining clips described in U.S. Pat. No. 10,208,874 to Geiger et al., issued Feb. 19, 2019, the disclosure of which is incorporated herein by reference. In other implementations, the fixing that is configured to fasten over the edge 176 of the workpiece 170 to connect the clip portion 110 with an end portion of the workpiece is a wedge clip fixing or another type of fixing. Examples of wedge clip fixings include the bundle flange mounts described in U.S. Pat. No. 11,209,030 to Vaughn et al., issued Dec. 28, 2021, the disclosure of which is incorporated herein by reference.

FIG. 3 illustrates a clip portion 310 as a wedge clip fixing that includes one or more connectors that are configured to engage at least one web face (e.g., first web face 172, second web face 274) of a workpiece 170. The connectors may include a first connector that is configured to engage a first web face 172 of the workpiece 170 and a second connector that is configured to engage a second web face 274 of the workpiece 170. The clip portion 310 includes a clamp body 312 and a wedge-shaped retainer segment (wedge 314). The clamp body 312 includes an upper clamp arm 324 and a lower ramp arm 326 connected by a stress arm 328. The upper clamp arm 324 has a lower clamp surface 336 for contacting the first web face 172. The wedge 314 has an upper clamp surface 340 that is configured to contact the second web face 274 and a lower ramp surface 342 that is configured for slideable engagement with the lower ramp arm 326 to clamp the clip portion 310 on an edge of the workpiece 170. Once a desired clamping retention is achieved, the support bracket (e.g., support bracket 102, support bracket 402) can then be installed over the clamp body 312. In this way, the wedge-shaped retainer segment (wedge 314) is configured to slideably engage the clamp body 312 to clamp the clip portion 310 on the edge of the workpiece 170. The clip portion 310 includes at least one cable tie retainer (e.g., cable tie pass-through, cable tie retaining geometry, cable tie saddle) that is configured to receive a cable tie therethrough. A cable tie retainer (e.g., cable tie retainer 316, cable tie retainer 318) may include one or more apertures, slots, and the like.

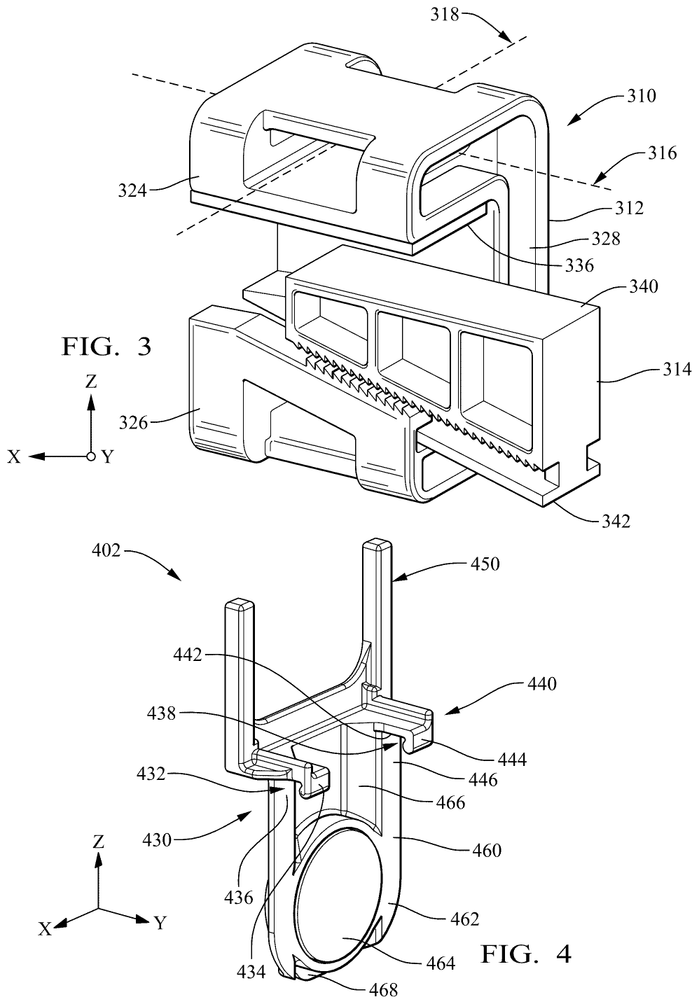

Referring now to FIG. 4, a second solar cable support bracket (support bracket 402) is illustrated. The system of the support bracket 402 may include a clip portion (illustrated in FIGS. 1, 2A, 2B, and 3). The support bracket 402 is similar to the support bracket 102 illustrated in FIGS. 1, 2A, and 3 and described above, except as detailed below. The support bracket 402 may be used in a system (e.g., system 100) that includes a workpiece (e.g., workpiece 170, which includes a first web face 172, a second web face 274, and an edge 176), a cable tie (e.g., cable tie 180), and an elongated object (e.g., elongated object 190). The support bracket 402 is configured to receive the workpiece (e.g., at an edge of the workpiece) and support the elongated object relative to the workpiece, as illustrated with respect to the support bracket 102 of FIG. 1. The support bracket 402 includes a first hanger portion 430, a second hanger portion 440, an object support section 450, and a body 460. The first hanger portion 430 is spaced apart from the second hanger portion 440, which would enable a clip portion (e.g., clip portion 110 of FIGS. 1, 2A, and 2B, clip portion 310 of FIG. 3) to be positioned therebetween. The object support section 450 includes a first cradle arm, a second cradle arm, a cross brace, and a cradle.

The first hanger portion 430 includes a first sidewall 434, a second sidewall 436, a first support ledge (not illustrated), and a first channel 432. The second hanger portion 440 includes a third sidewall 444, a fourth sidewall 446, a second support ledge 442, and a second channel 438. A pair of sidewalls may be located on opposing sides of a channel. For example, as illustrated in FIG. 4, the first hanger portion 430 includes a first pair of sidewalls (e.g., first sidewall 434 and second sidewall 436), which face one another across the first channel 432, and a second pair of sidewalls (e.g., third sidewall 444 and fourth sidewall 446), which face one another across the second channel 438. In the implementation illustrated in FIG. 4, the first channel 432 and the second channel 438 are aligned and configured to jointly receive the edge of the workpiece 170.

The body 460 of the support bracket 402 may define a recessed portion 466 that is configured to receive the clip portion (e.g., clip portion 110, clip portion 310). The body 460 of the support bracket 402 may include a face mount portion 462 that is configured to mount the support bracket 402 to a face or another surface of the workpiece 170. In one example, the face mount portion 462 includes at least one magnet 464 that is configured to magnetically attach to a face of a workpiece (e.g., the first web face, a side of an I-beam) of a ferromagnetic material. The magnet 464 may attach to the support bracket 402 via an adhesive (e.g., epoxy), a screw mount, a press fit, and the like. The face mount portion 462 may include a lever portion 468 (e.g., a finger tab) that is configured to assist a user in the detachment of the magnet 464 of the face mount portion 462 from the face of the workpiece 170.

The support bracket 402 may be configured for use as a tool that is configured for temporary installation to the workpiece 170. In such a configuration, the support bracket 402 may hold the elongated object by virtue of gravity force holding down the elongated object against the cross brace, flanked by the upright cradle arms. The support bracket 402 may be utilized to guide elongated objects (e.g., solar cables) during the pulling and/or routing of the elongated objects and until a separate fixing (e.g., edge clip fixing, wedge clip fixing) is attached to the workpiece 170 to fix the elongated objects to the workpiece 170 via the fixing. After the fixing is attached, the support bracket 402 may be removed. In implementations, the support bracket 402 may be permanent or semi-permanent, utilized to guide the elongated objects during the pulling of the elongated objects and left attached to the workpiece 170 after installation.

Referring now to FIGS. 5A-5D, a third solar cable support bracket (support bracket 502) is illustrated. The support bracket 502 is similar to the support bracket 102 illustrated in FIGS. 1, 2A, and 2B and described above, except as detailed below. The support bracket 502 may be used in a system (e.g., system 100) that includes a workpiece (e.g., workpiece 170, which includes a first web face 172, a second web face 274, and an edge 176), a cable tie (e.g., cable tie 180), and an elongated object (e.g., elongated object 190). The support bracket 502 is configured to receive the workpiece (e.g., at an edge of the workpiece) and support the elongated object relative to the workpiece, as illustrated with respect to the support bracket 102 of FIG. 1. The support bracket 502 includes a clip portion 510, a first hanger portion 530, a second hanger portion 540, and an object support section 550. The first hanger portion 530 is spaced apart from the second hanger portion 540 with the clip portion 510 positioned therebetween. The object support section 550 includes a first cradle arm, a second cradle arm, a cross brace, and a cradle.

The clip portion 510 includes a cable tie retainer 512, a first clip arm 520, a second clip arm 522, an end wall 548, and a gap 526. The clip portion 510 further includes a third clip arm 524. The clip arms of the clip portion 510 are spaced apart along the X-axis, and may alternate along a portion of the width of the support bracket 502, with the first clip arm 520 and the third clip arm 524 located on a first side and the second clip arm 522 located on a second side. In this way, the clip arms may sandwich the workpiece when the clip portion 510 engages the workpiece. Further, the clip arms may enable the clip portion to adjust to receive varying thicknesses of workpieces.

As discussed above, a support bracket may include at least one rib that is configured to bend a loose cable tie inserted through a cable tie retainer to retain the cable tie on the support bracket. For example, as illustrated in FIG. 5B, the support bracket 502 includes ribs (e.g., rib 560, rib 562) that are configured to provide a static grip on a cable tie 180 while installed in the cable tie retainer 512. In this way, a support bracket may be provided to customers preassembled with a pre-installed cable tie inserted through the cable tie retainer 512.

The first hanger portion 530 includes a first sidewall 534, a second sidewall 536, a first support ledge (not illustrated), and a first channel 532. The second hanger portion 540 includes a third sidewall 544, a fourth sidewall 546, a second support ledge 542, and a second channel 538. A pair of sidewalls may be located on opposing sides of a channel. For example, as illustrated in FIGS. 5A-5D, the first hanger portion 530 includes a first pair of sidewalls (e.g., first sidewall 534 and second sidewall 536), which face one another across the first channel 532, and a second pair of sidewalls (e.g., third sidewall 544 and fourth sidewall 546), which face one another across the second channel 538. In the implementation illustrated in FIGS. 5A-5D, the gap 526, the first channel 532, and the second channel 538 are configured to jointly receive the edge of the workpiece. In implementations, the gap, first channel, and/or second channel may be integrated into a joint channel.

An upper end (e.g., proximal end) of a gap and/or a channel of a support bracket (e.g., support bracket 102, support bracket 402, support bracket 502, support bracket 602, support bracket 702, support bracket 802) may be configured to guide and/or self-center the support bracket on the edge 176 of the workpiece 170. In some implementations, the upper end may have a V-shaped cross-section.

For example, as illustrated in FIG. 5D, the upper end (e.g., the end of the second channel 538 at the second support ledge 542) has a V-shape. The V-shape may be configured to accommodate multiple panel (e.g., edge) thicknesses. As used herein, the term “V-shape” refers to a gap (e.g., V-shaped gap) and/or a channel (e.g., V-shaped channel) whose side faces are inclined, like the shape of the letter “V” of the modern English alphabet, having an end that tapers to a point. In some cases, the term V-shape may also refer to a shape that tapers to a curved end (e.g., a U-shaped cross-section), a square end, an angled end, and/or a rectangular end, rather than to a point.

A sidewall (e.g., an inner sidewall, an outer sidewall) of a support bracket (e.g., support bracket 102, support bracket 402, support bracket 502, support bracket 602, support bracket 702, support bracket 802) may include an angled guide feature that protrudes from the sidewall. The angled guide feature may be located at a distal end (e.g., lower end) of a sidewall. For example, as illustrated in FIGS. 5A-5D, the third sidewall 544 includes a first angle guide feature 552 and the fourth sidewall 546 includes a second angle guide feature 554. An angled guide feature may be configured to provide an improved lead-in for guiding the edge into the channel. The angled guide feature may also assist in the self-centering of the support bracket on the edge. The angled guide feature may apply a preload force on varying edge thicknesses, which may enable the support bracket to grip the edge more tightly. The angled guide feature may also stiffen the sidewall.

A support bracket (e.g., support bracket 102, support bracket 402, support bracket 502, support bracket 602, support bracket 702, support bracket 802) may include a sidewall that is longer or shorter than another sidewall (e.g., an opposing sidewall, an adjacent sidewall). For example, as illustrated in FIGS. 5C and 5D, the third sidewall 544 is shorter than the fourth sidewall 546 and the first sidewall 534 is shorter than the fourth sidewall 546, which may result in distal ends of the sidewalls having different elevations, which may provide for a larger clip target on the edge during installation. The support bracket 502 illustrated in FIG. 5 includes a similar structure. In this way, an installer may not need to precisely align the clip portion and/or hanger portion with the edge but instead may be permitted to push the support bracket (e.g., clip portion and/or hanger portion(s)) onto the edge at various angles, which may help the installation process if clearance above the edge is limited.

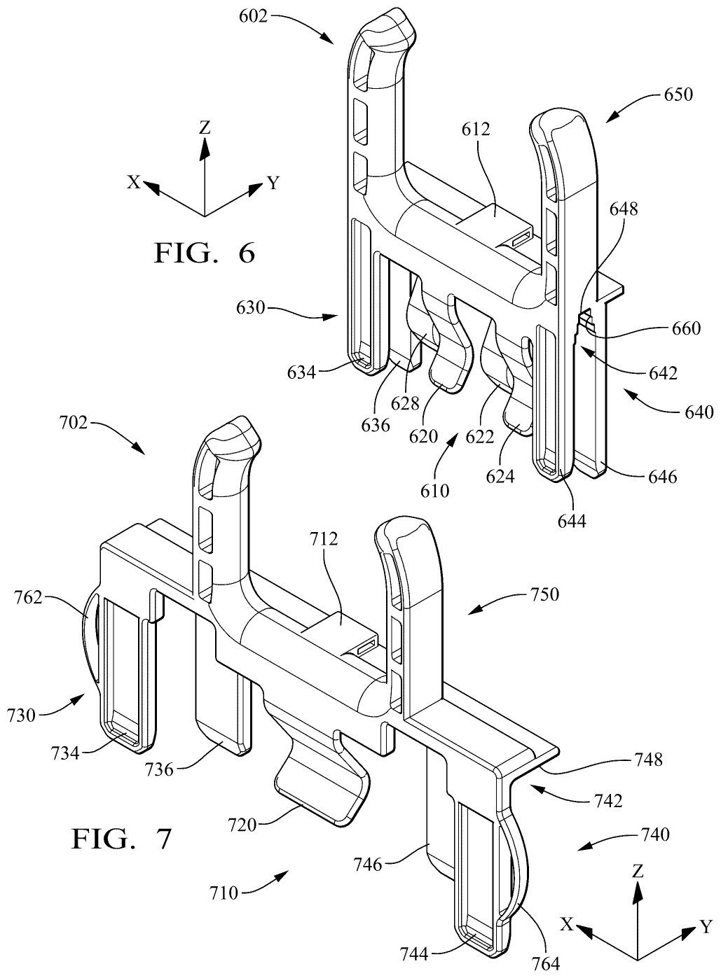

Referring now to FIG. 6, a fourth solar cable support bracket (support bracket 602) is illustrated. The support bracket 602 is similar to the support brackets (e.g., support bracket 102, support bracket 502) illustrated in the figures and described above, except as detailed below. The support bracket 602 may be used in a system (e.g., system 100) that includes a workpiece (e.g., workpiece 170, which includes a first web face 172, a second web face 274, and an edge 176), a cable tie (e.g., cable tie 180), and an elongated object (e.g., elongated object 190). The support bracket 602 is configured to receive the workpiece (e.g., at an edge of the workpiece) and support the elongated object relative to the workpiece, as illustrated with respect to the support bracket 102 of FIG. 1.

The support bracket 602 includes a clip portion 610, a cable tie retainer 612, at least one hanger portion (e.g., first hanger portion 630, second hanger portion 640), and an object support section 650. The first hanger portion 630 is spaced apart from the second hanger portion 640 with the clip portion 610 positioned therebetween. The object support section 650 includes a first cradle arm, a second cradle arm, a cross brace, and a cradle.

The clip portion 610 includes one or more clip arms (e.g., a first clip arm 620, a second clip arm 622, a third clip arm 624, a fourth clip arm 628), an end wall (not illustrated), and a gap (not illustrated). The clip arms of the clip portion 610 are spaced apart along the X-axis, alternating along a portion of the width of the support bracket 602, with the first clip arm 620 and the third clip arm 624 located on a first side and the second clip arm 622 and the fourth clip arm 628 located on a second side. In this way, the clip arms may sandwich the workpiece when the clip portion 610 engages the workpiece. The first hanger portion 630 includes a first sidewall 634, a second sidewall 636, a support ledge (not illustrated), and a channel (not illustrated). The second hanger portion 640 includes a first sidewall 644, a second sidewall 646, a support ledge 648, and a channel 642.

The support bracket 602 may include a cable tie retainer that defines at least one aperture, slot, and the like that is configured to receive a cable tie (e.g., cable tie 180) therethrough. The cable tie may be utilized to attach the elongated object to the support bracket 602. In implementations, one or more of the clip portion 610 or a hanger portion (e.g., first hanger portion 630, second hanger portion 640) may include a cable tie retainer.

An upper end (e.g., proximal end) of a channel (e.g., channel 642) may be configured to guide and/or self-center the support bracket 602 on the edge (e.g., edge 176 in FIG. 1) of the workpiece. In some implementations, at least the upper end of the channel may have a V-shaped cross-section, defining a V-shaped channel. The V-shaped channel may be configured to accommodate multiple panel (e.g., edge) thicknesses. The V-shaped channel may define a step thickness feature 660 that is configured to accommodate multiple panel (e.g., edge) thicknesses. The step thickness feature 660 may be corbeled in shape and define one or more steps projecting inwards from side faces of the V-shaped channel. While only illustrated in the support bracket 602 of FIG. 6, a step thickness feature may be present in gaps and/or channels of other support bracket implementations (e.g., support bracket 102, support bracket 402, support bracket 502, support bracket 602).

Referring now to FIG. 7, a fifth solar cable support bracket (support bracket 702) is illustrated. The support bracket 702 is similar to the support brackets (e.g., support bracket 102, support bracket 502, support bracket 602) illustrated in the figures and described above, except as detailed below. The support bracket 702 may be used in a system (e.g., system 100) that includes a workpiece (e.g., workpiece 170, which includes a first web face 172, a second web face 274, and an edge 176), a cable tie (e.g., cable tie 180), and an elongated object (e.g., elongated object 190). The support bracket 702 is configured to receive the workpiece (e.g., at an edge of the workpiece) and support the elongated object relative to the workpiece, as illustrated with respect to the support bracket 102 of FIG. 1.

The support bracket 702 includes a clip portion 710, a cable tie retainer 712, a first hanger portion 730, a second hanger portion 740, and an object support section 750. The first hanger portion 730 is spaced apart from the second hanger portion 740 with the clip portion 710 positioned therebetween. The object support section 750 includes a first cradle arm, a second cradle arm, a cross brace, and a cradle. The support bracket 702 may include a cable tie retainer that defines at least one aperture, slot, and the like that is configured to receive a cable tie (e.g., cable tie 180) therethrough. The cable tie may be utilized to attach the elongated object to the support bracket 702. In implementations, one or more of the clip portion 710 or a hanger portion (e.g., first hanger portion 730, second hanger portion 740) may include a cable tie retainer.

The first hanger portion 730 includes a first sidewall 734, a second sidewall 736, a first support ledge (not illustrated), and a first channel (not illustrated). The second hanger portion 740 includes a third sidewall 744, a fourth sidewall 746, a second support ledge 748, and a second channel 742. A pair of sidewalls may be located on opposing sides of a channel. The first hanger portion 730 includes a first pair of staggered sidewalls (e.g., first sidewall 734 and second sidewall 736), which are staggered from one another across the first channel, and a second pair of sidewalls (e.g., third sidewall 744 and fourth sidewall 746), which are staggered from one another across the second channel 742. The first sidewall 734 and the third sidewall 744 are on a same side of the support bracket 702 and the second sidewall 736 and the fourth sidewall 746 are on a same side of the support bracket 702. The clip portion 710 includes one or more clip arms (e.g., a first clip arm 720), an end wall (not illustrated), and a gap (not illustrated). The first clip arm 720 in this implementation is positioned on an opposite side of the support bracket 702 from the adjacent sidewalls (e.g., second sidewall 736, fourth sidewall 746). The clip portion 710, the first hanger portion 730, and the second hanger portion 740 are configured to slide onto the edge of the workpiece. One or more of the outer sidewalls (e.g., the first sidewall 734, the third sidewall 744) may include a resilient tab (e.g., resilient tab 762, resilient tab 764) that is configured to flex and provide a tighter fit on a range of edge widths.

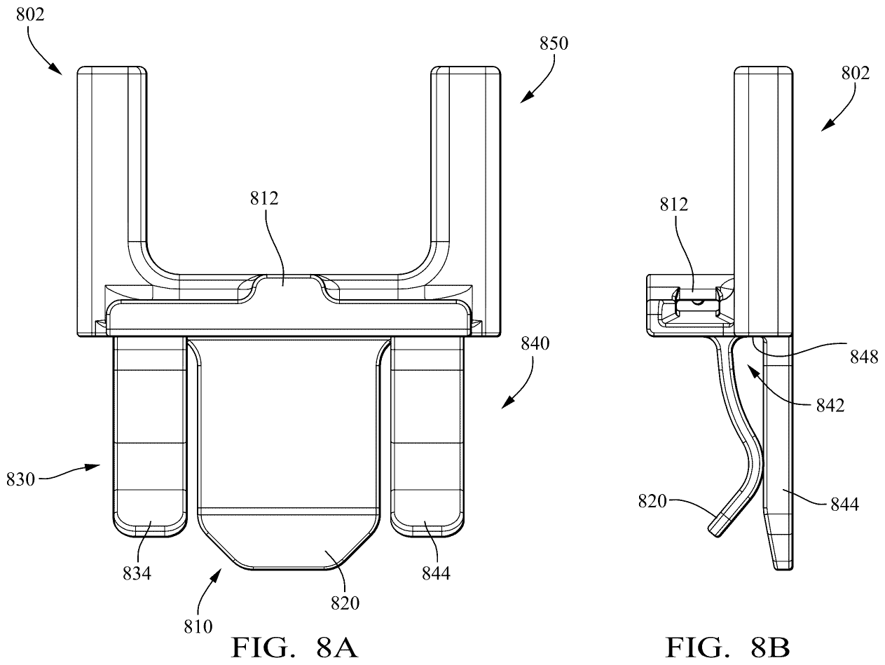

Referring now to FIGS. 8A and 8B, a sixth solar cable support bracket (support bracket 802) is illustrated. The support bracket 802 is similar to the support brackets (e.g., support bracket 102, support bracket 502, support bracket 602, support bracket 702) illustrated in the figures and described above, except as detailed below. The support bracket 802 may be used in a system (e.g., system 100) that includes a workpiece (e.g., workpiece 170, which includes a first web face 172, a second web face 274, and an edge 176), a cable tie (e.g., cable tie 180), and an elongated object (e.g., elongated object 190). The support bracket 802 is configured to receive the workpiece (e.g., at an edge of the workpiece) and support the elongated object relative to the workpiece, as illustrated with respect to the support bracket 102 of FIG. 1.

The support bracket 802 includes a clip portion 810, a first hanger portion 830, a second hanger portion 840, and an object support section 850. The first hanger portion 830 is spaced apart from the second hanger portion 840 with the clip portion 810 positioned therebetween. The object support section 850 includes a first cradle arm, a second cradle arm, a cross brace, and a cradle.

The first hanger portion 830 includes a first sidewall 834, a first support ledge (not illustrated), and a first channel (not illustrated). The second hanger portion 840 includes a third sidewall 844, a second support ledge 848, and a second channel 842. The clip portion 810 includes one or more clip arms (e.g., a first clip arm 820), an end wall (not illustrated), and a gap (not illustrated). The first sidewall 834 and the third sidewall 844 are on a same side of the support bracket 802, and the first clip arm 820 is on an opposite side of the support bracket 802. The clip portion 810, the first hanger portion 830, and the second hanger portion 840 are configured to slide onto the edge of the workpiece. In this implementation, the first hanger portion 830 includes at least one sidewall (e.g., first sidewall 834, third sidewall 844) on a first side of the support bracket 802, a first connector of the clip portion 810 includes at least one resilient clip arm (e.g., first clip arm 820) on a second side of the support bracket 802, and the resilient clip arm (e.g., first clip arm 820) and the sidewall (e.g., first sidewall 834, third sidewall 844) define a gap therebetween that is configured to receive the edge therein.

The support bracket 802 includes a cable tie retainer 812 (e.g., cable tie pass-through, cable tie retaining geometry, cable tie saddle) that defines at least one aperture, slot, and the like that is configured to receive a cable tie (e.g., cable tie 180) therethrough. The cable tie may be utilized to attach the elongated object to the support bracket 802. In implementations, one or more of the clip portion 810 or a hanger portion (e.g., first hanger portion 830, second hanger portion 840) may include a cable tie retainer.

Components of a solar cable support bracket may be fabricated of any suitable material, including polymeric material and metal. A suitable polymeric material may include one or more of polyamide (PA), polypropylene (PP), polyethylene (PE), polyphenylene sulfide (PPS), polyether ether ketone (PEEK), polyaryletherketone (PAEK), ethylene tetrafluoroethylene (ETFE), polyacetal (POM), polybutylene terephthalate (PBT), ultraviolet (UV) stabilized polyacetal (POMUV), acrylonitrile styrene acrylate (ASA), cross-linked thermoplastics, partially cross-linked thermoplastics, higher-temperature resins, UV resistant resins, other thermoplastic materials, and the like, and copolymers, blends, or alloys thereof, as well as fiber reinforced materials. A suitable polymeric material may include one or more additives (e.g., heat stabilizers (e.g., copper iodide), impact modifiers (e.g., polyolefin, urethane, rubber), UV stabilizers (e.g., carbon black, hindered amine light stabilizers (HALS)), flame retardants (e.g., nitrogen-based halogen-free flame retardants, melamine cyanurate, melamine borate, ammonium polyphosphate), colorants, and the like). In implementations, the resilient cantilevered prongs may be formed of a metal material. A suitable metal material may include spring steel, stainless steel, aluminum, and the like. One or more of the components of the clamp assembly may be formed of the same material as the other components, or of a different material than the other components. One or more of the components of a support bracket may be integrally formed through an injection-molding process or another suitable process.

Some additional examples of solar cable support brackets are as follows:

### Example 1

A support bracket configured to receive an edge of a workpiece and support an elongated object relative to the workpiece, the support bracket comprising: a first hanger portion configured to support the edge of the workpiece and limit a rotation of the support bracket on the edge of the workpiece; a clip portion configured to fasten over the edge of the workpiece, the clip portion including a first connector configured to engage at least one of a first web face or a second web face of the workpiece; a cable tie retainer defining an aperture configured to receive a cable tie therethrough, the cable tie retainer configured to receive the cable tie to attach the elongated object to the support bracket; and an object support section configured to support the elongated object.

### Example 2

The support bracket of Example 1, wherein the clip portion further comprises: a first clip arm; a second clip arm arranged opposite the first clip arm; and a first end wall interconnecting the first and second clip arms, wherein the first and second clip arms define a gap therebetween that is configured to receive the edge of the workpiece through an opening opposite the first end wall.

### Example 3

The support bracket of Example 2, wherein the clip portion further comprises a second connector configured to engage a second web face of the workpiece, the second web face opposite the first web face, wherein the first connector comprises a first resilient cantilevered prong projecting into the gap from the first clip arm, and wherein the second connector comprises a second resilient cantilevered prong projecting into the gap from the second clip arm.

### Example 4

The support bracket of Example 2, wherein the first connector configured to engage at least one of the first web face or the second web face of the workpiece comprises a wedge clip fixing comprising: a clamp body; and a wedge-shaped retainer segment, the wedge-shaped retainer segment configured to slideably engage the clamp body to clamp the clip portion on the edge of the workpiece.

### Example 5

The support bracket of Example 2, wherein the first hanger portion further comprises at least one sidewall on a first side of the support bracket, wherein the first connector further comprises at least one resilient clip arm on a second side of the support bracket, and wherein the resilient clip arm and the sidewall define a gap therebetween, the gap configured to receive the edge therein.

### Example 6

The support bracket of Example 1, wherein the support bracket includes at least one rib configured to bend a loose cable tie inserted through a cable tie retainer to retain the cable tie on the support bracket.

### Example 7

The support bracket of Example 1, wherein the support bracket further comprises: a face mount portion that is configured to engage the first web face of the workpiece, wherein the face mount portion includes a magnet.

### Example 8

The support bracket of Example 1, wherein the object support section further comprises: a cross brace; a first cradle arm; and a second cradle arm, wherein the first and second cradle arms are spaced apart and define a cradle therebetween.

### Example 9

The support bracket of Example 2, wherein the gap is a V-shaped gap and configured to self-center the support bracket on the edge of the workpiece.

### Example 10

The support bracket of Example 9, wherein the V-shaped gap is corbelled.

### Example 11

The support bracket of Example 1, wherein the first hanger portion further comprises: a first sidewall spaced apart from a second sidewall by a first support ledge, the first and second sidewalls defining a first channel therebetween that is configured to receive the edge of the workpiece through an opening opposite the first support ledge, wherein the first support ledge is configured to rest on the edge of the workpiece.

### Example 12

The support bracket of Example 11, wherein the first sidewall is configured to contact the first web face of the workpiece and the second sidewall is configured to contact the second web face of the workpiece, the second web face opposite the first web face.

### Example 13

The support bracket of Example 1, further comprising: a second hanger portion configured to hang over the edge of the workpiece, the second hanger portion spaced apart from the first hanger portion.

### Example 14

The support bracket of Example 13, wherein the clip portion is positioned between the first hanger portion and the second hanger portion.

### Example 15

The support bracket of Example 13, wherein the second hanger portion further comprises: a third sidewall spaced apart from a fourth sidewall by a second support ledge, the third and fourth sidewalls defining a second channel therebetween that is configured to receive the edge of the workpiece through a second opening opposite the second support ledge, the second support ledge configured to rest on the edge of the workpiece.

### Example 16

The support bracket of Example 13, wherein the cable tie retainer is defined on at least one of the clip portion, the first hanger portion, or the second hanger portion.

### Example 17

The support bracket of Example 13, wherein the first hanger portion further comprises: a first sidewall spaced apart from a second sidewall by a first support ledge, the first and second sidewalls defining a first channel therebetween that is configured to receive the edge of the workpiece through an opening opposite the first support ledge, wherein the first support ledge is configured to rest on the edge of the workpiece, wherein the second hanger portion further comprises: a third sidewall spaced apart from a fourth sidewall by a second support ledge, the third and fourth sidewalls defining a second channel therebetween that is configured to receive the edge of the workpiece through a second opening opposite the second support ledge, the second support ledge configured to rest on the edge of the workpiece, and wherein the first, second, third, and fourth sidewalls are rigid sidewalls.

### Example 18

A support bracket configured to receive an edge of a workpiece and support an elongated object relative to the workpiece, the support bracket comprising: a first hanger portion configured to support the edge of the workpiece and limit a rotation of the support bracket on the edge of the workpiece, the first hanger portion comprising: a first sidewall spaced apart from a second sidewall by a first support ledge, the first and second sidewalls defining a first channel therebetween that is configured to receive the edge of the workpiece through an opening opposite the first support ledge, wherein the first support ledge is configured to rest on the edge of the workpiece; a second hanger portion configured to support the edge of the workpiece and limit the rotation of the support bracket on the edge of the workpiece, the second hanger portion spaced apart from the first hanger portion, the second hanger portion comprising: a third sidewall spaced apart from a fourth sidewall by a second support ledge, the third and fourth sidewalls defining a second channel therebetween that is configured to receive the edge of the workpiece through a second opening opposite the second support ledge, the second support ledge configured to rest on the edge of the workpiece; and an object support section configured to support the elongated object.

### Example 19

The support bracket of Example 18, further comprising: a clip portion configured to fasten over the edge of the workpiece, the clip portion including a first connector configured to engage a first web face of the workpiece, the clip portion positioned between the first hanger portion and the second hanger portion; and a cable tie retainer defining an aperture configured to receive a cable tie therethrough, the cable tie retainer configured to receive the cable tie to attach the elongated object to the support bracket.

### Example 20

The support bracket of Example 19, wherein the cable tie retainer is defined on at least one of the clip portion, the first hanger portion, or the second hanger portion.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

The terms “rigid,” “flexible,” and “resilient” may be used herein to distinguish characteristics of portions of certain features of the support brackets disclosed herein. The use of the term “rigid” indicates that a described element is devoid of flexibility such that it does not readily lose its overall shape when force is applied by hand, and in fact it may break if an attempt to bend it is made with sufficient force. The use of the term “flexible” indicates that the described element is capable of repeated bending such that it may be bent into different shapes and does not retain a general shape but instead readily deforms when force is applied. The use of the term “resilient” indicates that the described element has such flexible features and also has a tendency to return to its initial general shape without permanent deformation once a force that causes such flexure is removed.

In implementations, solar cable support brackets may include one or more of the features of the techniques and apparatuses illustrated in the drawings and described above. Although implementations of solar cable support brackets have been described in language specific to certain features and/or methods, the subject of the appended claims is not necessarily limited to the specific features or methods described. Rather, the specific features and methods are disclosed as example implementations of solar cable support brackets.

What is claimed is:

1. A support bracket configured to receive an edge of a workpiece and support an elongated object relative to the workpiece, the support bracket comprising:
a first hanger portion configured to support the edge of the workpiece and limit a rotation of the support bracket on the edge of the workpiece;
a clip portion configured to fasten over the edge of the workpiece, the clip portion including a first connector configured to engage at least one of a first web face or a second web face of the workpiece;
a cable tie retainer defining an aperture configured to receive a cable tie therethrough, the cable tie retainer configured to receive the cable tie to attach the elongated object to the support bracket; and
an object support section configured to support the elongated object.

2. The support bracket of claim 1, wherein the clip portion further comprises:
a first clip arm;
a second clip arm arranged opposite the first clip arm; and
a first end wall interconnecting the first and second clip arms,
wherein the first and second clip arms define a gap therebetween that is configured to receive the edge of the workpiece through an opening opposite the first end wall.

3. The support bracket of claim 2,
wherein the clip portion further comprises a second connector configured to engage a second web face of the workpiece, the second web face opposite the first web face,
wherein the first connector comprises a first resilient cantilevered prong projecting into the gap from the first clip arm, and
wherein the second connector comprises a second resilient cantilevered prong projecting into the gap from the second clip arm.

4. The support bracket of claim 2, wherein the first connector configured to engage at least one of the first web face or the second web face of the workpiece comprises a wedge clip fixing comprising:
a clamp body; and
a wedge-shaped retainer segment, the wedge-shaped retainer segment configured to slideably engage the clamp body to clamp the clip portion on the edge of the workpiece.

5. The support bracket of claim 2,
wherein the first hanger portion further comprises at least one sidewall on a first side of the support bracket,
wherein the first connector further comprises at least one resilient clip arm on a second side of the support bracket, and
wherein the resilient clip arm and the sidewall define a gap therebetween, the gap configured to receive the edge therein.

6. The support bracket of claim 1, wherein the support bracket includes at least one rib configured to bend a loose cable tie inserted through a cable tie retainer to retain the cable tie on the support bracket.

7. The support bracket of claim 1, wherein the support bracket further comprises:
a face mount portion that is configured to engage the first web face of the workpiece, wherein the face mount portion includes a magnet.

8. The support bracket of claim 1, wherein the object support section further comprises:
a cross brace;
a first cradle arm; and
a second cradle arm, wherein the first and second cradle arms are spaced apart and define a cradle therebetween.

9. The support bracket of claim 2, wherein the gap is a V-shaped gap and configured to self-center the support bracket on the edge of the workpiece.

10. The support bracket of claim 9, wherein the V-shaped gap is corbelled.

11. The support bracket of claim 1, wherein the first hanger portion further comprises:
a first sidewall spaced apart from a second sidewall by a first support ledge, the first and second sidewalls defining a first channel therebetween that is configured to receive the edge of the workpiece through an opening opposite the first support ledge, wherein the first support ledge is configured to rest on the edge of the workpiece.

12. The support bracket of claim 11, wherein the first sidewall is configured to contact the first web face of the workpiece and the second sidewall is configured to contact the second web face of the workpiece, the second web face opposite the first web face.

13. The support bracket of claim 1, further comprising:
a second hanger portion configured to hang over the edge of the workpiece, the second hanger portion spaced apart from the first hanger portion.

14. The support bracket of claim 13, wherein the clip portion is positioned between the first hanger portion and the second hanger portion.

15. The support bracket of claim 13, wherein the second hanger portion further comprises:
a third sidewall spaced apart from a fourth sidewall by a second support ledge, the third and fourth sidewalls defining a second channel therebetween that is configured to receive the edge of the workpiece through a second opening opposite the second support ledge, the second support ledge configured to rest on the edge of the workpiece.

16. The support bracket of claim 13, wherein the cable tie retainer is defined on at least one of the clip portion, the first hanger portion, or the second hanger portion.

17. The support bracket of claim 13,
wherein the first hanger portion further comprises:
a first sidewall spaced apart from a second sidewall by a first support ledge, the first and second sidewalls defining a first channel therebetween that is configured to receive the edge of the workpiece through an opening opposite the first support ledge, wherein the first support ledge is configured to rest on the edge of the workpiece,
wherein the second hanger portion further comprises:
a third sidewall spaced apart from a fourth sidewall by a second support ledge, the third and fourth sidewalls defining a second channel therebetween that is configured to receive the edge of the workpiece through a second opening opposite the second support ledge, the second support ledge configured to rest on the edge of the workpiece, and
wherein the first, second, third, and fourth sidewalls are rigid sidewalls.

18. A support bracket configured to receive an edge of a workpiece and support an elongated object relative to the workpiece, the support bracket comprising:
a first hanger portion configured to support the edge of the workpiece and limit a rotation of the support bracket on the edge of the workpiece, the first hanger portion comprising:
a first sidewall spaced apart from a second sidewall by a first support ledge, the first and second sidewalls defining a first channel therebetween that is configured to receive the edge of the workpiece through an opening opposite the first support ledge, wherein the first support ledge is configured to rest on the edge of the workpiece;
a second hanger portion configured to support the edge of the workpiece and limit the rotation of the support bracket on the edge of the workpiece, the second hanger portion spaced apart from the first hanger portion, the second hanger portion comprising:
a third sidewall spaced apart from a fourth sidewall by a second support ledge, the third and fourth sidewalls defining a second channel therebetween that is configured to receive the edge of the workpiece through a second opening opposite the second support ledge, the second support ledge configured to rest on the edge of the workpiece; and
an object support section configured to support the elongated object.

19. The support bracket of claim 18, further comprising:
a clip portion configured to fasten over the edge of the workpiece, the clip portion including a first connector configured to engage a first web face of the workpiece, the clip portion positioned between the first hanger portion and the second hanger portion; and
a cable tie retainer defining an aperture configured to receive a cable tie therethrough, the cable tie retainer configured to receive the cable tie to attach the elongated object to the support bracket.

20. The support bracket of claim 19, wherein the cable tie retainer is defined on at least one of the clip portion, the first hanger portion, or the second hanger portion.
